(19) United States
(12) Patent Application Publication
(10) Pub. No.: US 2007/0221286 A1
(43) Pub. Date: Sep. 27, 2007

(54) Apparatus and method for producing water-filled tire

(76) Inventor: Vinit Chantalat, Pleasant Hill, CA (US)

Correspondence Address: PATENTABILITY ASSOCIATES, P.O. BOX 9551, SAN JOSE, CA, 95157, US

(21) Appl. No.: 11/386,330

(22) Filed: Mar. 22, 2006

(51) Int. Cl. B08B 3/00; B08B 7/00

(52) U.S. Cl. 141/38; 134/34; 134/42; 152/DIG. 5

(57) ABSTRACT

A tire is filled with water by a method that includes partially filling the tire with water, introducing a water-soluble gas into the tire and venting the gas mixture to the atmosphere. The process is repeated one or more times, the amount of air in the tire being reduced on each repetition. When the amount of air remaining in the tire has been reduced to a desired level, the tire is agitated to dissolve the remaining water-soluble gas in the water. In an alternative method, air is evacuated from the tire and gaseous water is injected into the tire.

### FIELD OF THE INVENTION

This invention relates to tires for automobiles and other vehicles.

### BACKGROUND

As is well known, automobiles and other vehicles currently rely on tires that are filled with air. Since air is compressible, the captive air in a tire obeys Boyle's law:
P×V=K
where P is the air pressure, V is interior volume of the tire, and K is a constant. It is assumed that temperature is held constant.

When a tire is initially inflated, the pressure is referred to as the “standing pressure.” Boyle's law becomes:
Pₛ×Vₛ=K
where Pₛ is the standing pressure and Vₛ is the volume of the tire with no load imposed on it.

When a load is imposed on the tire, the equation becomes:
P₁×V₁=K
where P₁ is the pressure in the tire under the load, and V₁ is the volume inside the loaded tire. Since P₁ must be greater than Pₛ to support the load, it follows that
V₁<Vₛ

In short, when a tire is filled with a compressible gas such as air, its volume decreases proportionately with the load on the tire. This volume reduction shows up mainly as a flat area where the tire meets the road. The tire is deformed. As a result of this deformation, a considerable amount of energy is required to roll the automobile or other vehicle. It is well known, for example, that the gas mileage of an automobile suffers when its tire pressure is reduced. While, conversely, the gas mileage may be improved by increasing the tire pressure, the energy “wasted” in deforming the tires can not be reduced to an acceptable level. Moreover, the flattening of the tire causes the rubber to rub against the road surface in a way that creates road noise, heat and increased tire wear.

Because air-filled tires are relatively light in comparison to the weight of the vehicle, the center of gravity of the vehicle is relatively high. This makes the vehicles susceptible to overturning on sharp curves. The tendency of sport utility vehicles (SUVs), in particular, to overturn has received considerable publicity in the media lately.

If an air-filled tire is punctured, it normally becomes flat in a short period of time and thus requires immediate attention. This can occur at very inopportune moments, such as when the car is being driven on a congested superhighway. Pulling the car onto the shoulder to change a tire can be very hazardous in such circumstances.

Air-filled tires can burst or explode when the car is driven over a pothole or speed bump, causing the driver to lose control of the car and putting the driver and other occupants of the car in extreme danger.

Air contains about 21% oxygen. Oxidation of rubber causes it to dry out and crack. Thus contact between the oxygen in air and the tire rubber reduces the strength and life of the tire.

### SUMMARY

These problems are largely overcome with a tire that is filled with water, using the apparatus and method of this invention. In this manner, a tire can be filled with water with only a minimal air residue remaining in the tire. This is difficult to accomplish because the main constituents of air (O₂ and N₂) are relatively insoluble in water. If an air pocket remains in the tire, the tire will not be balanced. An unbalanced tire will shake the vehicle when it is spinning.

According to the method of this invention, a tire is partially filled with water, trapping and compressing the air in the tire. The trapped air is released until the remaining air in the tire is at, for example, atmospheric pressure. A gas such as CO₂ that is highly soluble in water is then introduced under pressure into the tire, creating a mixture of air and the water-soluble gas. The mixture is then vented to the atmosphere and an additional amount of the water-soluble gas is introduced into the tire under pressure. Again, the gases remaining in the tire are vented to the atmosphere.

This process is repeated several times. After each introduction of the water-soluble gas into the tire, the proportion of the water-soluble gas to air increases. For example, if CO₂ is introduced into the tire at 6 atmospheres of pressure (88.2 psi) and the process is repeated three times, the gas remaining in the tire will consist of only 1/216 (1/63) air and 215/216 CO₂.

Water, either pure water or another aqueous liquid such as water containing the water-soluble gas, is then introduced into the tire under pressure. The tire is then agitated, for example by spinning it, to dissolve all of the water-soluble gas in the water.

Additional water can then be added to increase the pressure in the tire to the desired standing pressure.

In an alternative method according to the invention, water containing a gas that is the gas is pumped out of the tire, leaving a near vacuum. Additional water containing the water-soluble gas is introduced into the tire, and the tire is agitated, for example by spinning, to dissolve any remaining gas. Additional water can then be added to increase the pressure in the tire to the desired standing pressure.

The water-filled tire of this invention largely overcomes the problems with air-filled tires described above. Since water is incompressible, the portion of the tire that is flattened against the road surface is greatly reduced. The amount of flattening is largely independent of the weight of the vehicle and its cargo. The greater mass of water as compared with air also increases the centrifugal force on the tire when it is spun, further reducing the flattening of the tire against the road surface. This effect becomes more pronounced as the speed of the vehicle is increased. Thus less energy is absorbed and wasted in deforming the tires as they roll on the road surface. Particularly on long trips, gas mileage is increased, saving fuel expense. Especially with the recent increases in the price of gasoline, this is an important factor. On shorter trips, it is believed that the increased energy required to move a heavier tire and the energy savings from reduced tire deformation generally offset each other. Moreover, because a water-filled tire weighs more that an air-filled tire, the vehicle will coast further when the gas pedal is released. The slight decrease in acceleration because of the greater weight of the tires does not affect safety appreciably and may in fact lead to safer driving habits. In fact, acceleration at high speeds is actually improved due to the centrifugal force effect described above.

In “stop and go” traffic, drivers can reduce energy consumption and brake pad wear by allowing more distance between the car in front of them and allowing their car to coast more.

The reduced flattening of the tires also reduces the stress on the steering system, particularly at higher speeds.

The increased weight of the tires lowers the center of gravity of the vehicle, lessening the tendency for it to overturn on sharp curves or at high speeds.

Using water instead of air to fill the tire increases tire lifetime since there is no oxygen in contact with the interior surfaces of the tire. Rubber has a moisture content of about 0.5%. Contact between the water and rubber preserves the moisture in the rubber. The tire will have a longer life and greater flexibility. The tire also tends to heat up less and makes less noise against the road. There is less rubbing between the tire and the road, and this also reduces the amount of wear on the tire.

Water leaks from a puncture in a tire at a rate up to 1,000 times slower than air. Thus the car can often be driven a considerable distance before repairs are necessary. It is rarely necessary to pull the car over immediately to change a tire. Moreover, leaks are easy to detect because water can be observed or the road or driveway surface. The tire needs to be filled only once a year or so, and only a small amount of water is required.

Water-filled tires have a higher dynamic coefficient of friction with the road than air-filled tires, decreasing the tendency of the tires to slide on the road surface. The vehicle will “hug the road” better and tilt less on sharp turns. Water-filled tires anchor the vehicle to the road better than air-filled tires. The vehicle stops well when braked.

Because water is incompressible, the tires will not burst or explode when driven over potholes and speed bumps. Moreover, the tendency of a vehicle with air-filled tires to oscillate up and down is eliminated.

The invention also comprises apparatus for performing the above methods. Apparatus for performing the first method comprises a gaseous water generator connected through a conduit to a connector for a tire valve stem. The conduit also includes a valve for controlling the flow of a gaseous water from the gaseous water generator to the connector. (Note that as used herein the term “gaseous water generator” refers to any device that operates to dissolve a water-soluble gas in water, whether or not the gas is CO₂; the term “gaseous water” refers to water that contains a significant amount of a dissolved gas.)

Apparatus for performing the second method comprises a gaseous water generator connected through a first conduit to a connector for a tire valve stem and a vacuum pump connected through second conduit to the tire valve stem. The first conduit contains a first valve for controlling the flow of gaseous water to the tire valve stem; the second conduit contains a second valve for controlling a flow of gas from the connector to the vacuum pump. A portion of the first and second conduits may overlap.

According to another aspect, the invention also comprises a gaseous liquid generator. The gaseous liquid generator comprises a mixing block having a gas inlet, a liquid inlet and a liquid outlet. The gas inlet is connected through a first conduit to a source of pressurized water-soluble gas. The liquid inlet is connected through a second conduit to a source of pressurized liquid. The liquid outlet is connected through a third conduit to a pump, which is preferably a centrifugal pump but may be a piston pump or a rotary vane pump, for example. The first (gas) conduit may include a first valve such as a gas solenoid valve, a back flow valve and a gas flow regulator. The second (liquid) conduit may include a back flow valve and a flow regulator. The mixing block may have additional gas/liquid inlets if it is desired to produce a gaseous liquid that contains more than one liquid and/or dissolved gas.

In one embodiment, the mixing block includes a constricted portion of a water flow path. A gas flow path intersects the constricted portion of the water flow path. In another embodiment, the mixing block includes a small tube that is in flow communication with the gas inlet and that projects into an interior region of a water flow path.

According to yet another aspect of the invention, the gaseous water generator is used to produce aerated or carbonated or ozonated water by using air, carbon dioxide or ozone, respectively, as the pressurized water-soluble gas. Aerated or ozonated water has many uses in fish and shrimp farms and in other agricultural applications. Aerators and ozonators can also be used to purify water in sewerage plants. Carbonated or ozonated water can be used as a cleansing or germicidal agent for human hair and skin and for foodstuffs.

In some embodiments of this invention, the inlet of the centrifugal pump is used as the mixing block.

### BRIEF DESCRIPTION OF THE DRAWINGS

The invention will be better understood by reference to the following drawings.

FIGS. 1A-1G illustrate the steps of a method of filling a tire with water in accordance with the invention.

FIG. 2 illustrates apparatus that can be used to fill the tire with a water-soluble gas.

FIG. 3 illustrates apparatus that can be used in an alternative method of filling a tire with water.

FIG. 4 illustrates an apparatus that can be used to provide a source of gaseous water.

FIG. 5 illustrates an alternative apparatus that can be used to provide a source of gaseous water.

FIG. 6 illustrates an alternative form of mixing block that can be used in the apparatus shown in FIGS. 4 and 5.

FIG. 7 illustrates a preferred system for performing the method described in connection with FIG. 3.

FIG. 8 is a schematic diagram of a gaseous liquid generator in accordance with the invention.

FIG. 9 is a schematic diagram of a gaseous liquid generator capable of producing a gaseous liquid containing two liquids or gases.

FIG. 10 shows an arrangement for generating carbonated/ozonated water using a submersible pump in a tub.

FIG. 11 shows an alternative arrangement for generating carbonated/ozonated water using a submersible pump external to the tub.

FIG. 12 shows an aerator for an open pond in accordance with the invention.

FIG. 13 shows an aerator that can be used to provide aerated water for an aquarium or tank.

FIG. 14 shows an “aerator stick” that could be used in a shrimp farm or waste water tank or pond.

FIG. 15 shows a type of sudmersible centrifugal pump.

FIG. 16 shows an aerator wherein the centrifugal pump and motor are placed on the bottom of a pond or tank.

FIG. 17 shows an aerator wherein the centrifugal pump motor is mounted on a drive shaft housing above the surface of the water.

FIG. 18 shows an aerator mounted on the floor of a pond using a central pole and two wing poles.

FIG. 19 shows an aerator mounted to a U-shaped float.

### DETAILED DESCRIPTION

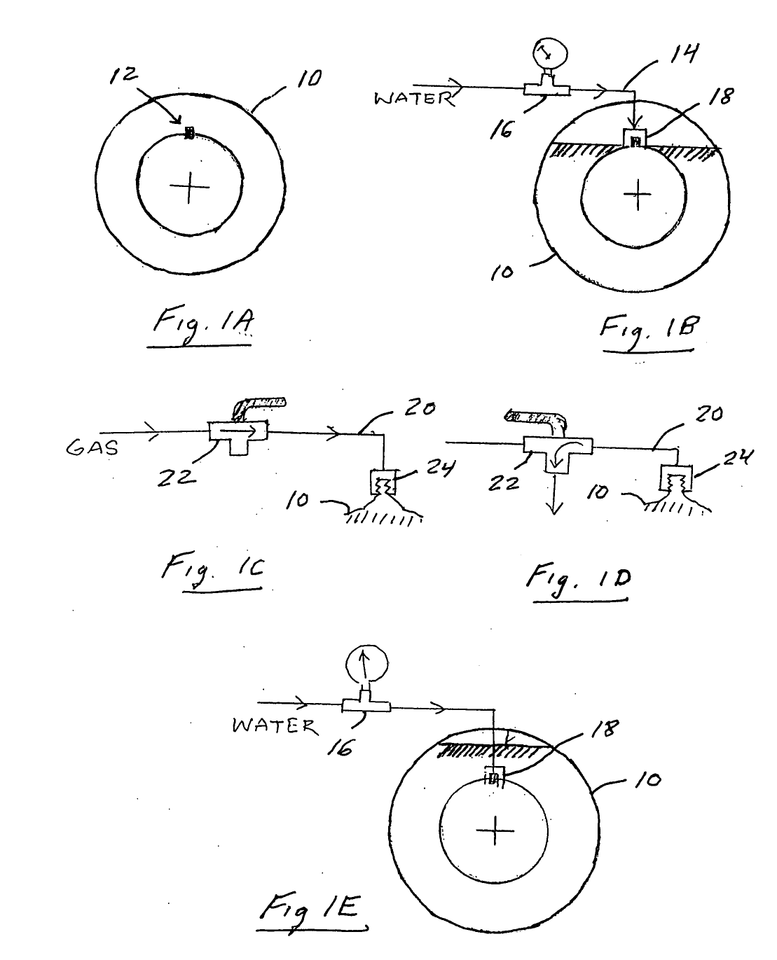

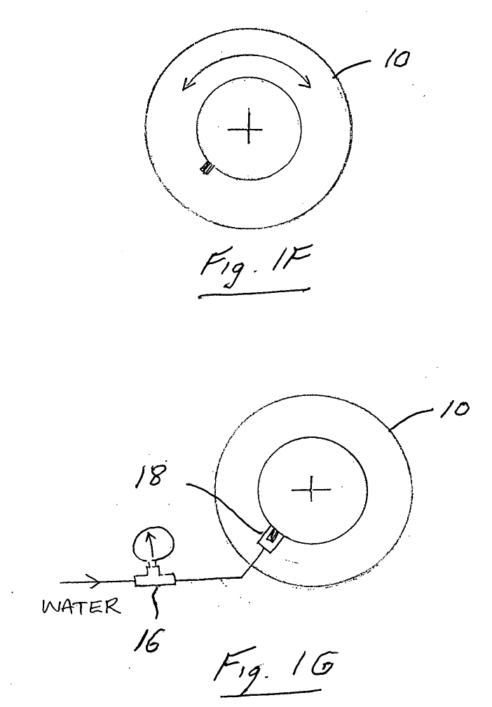

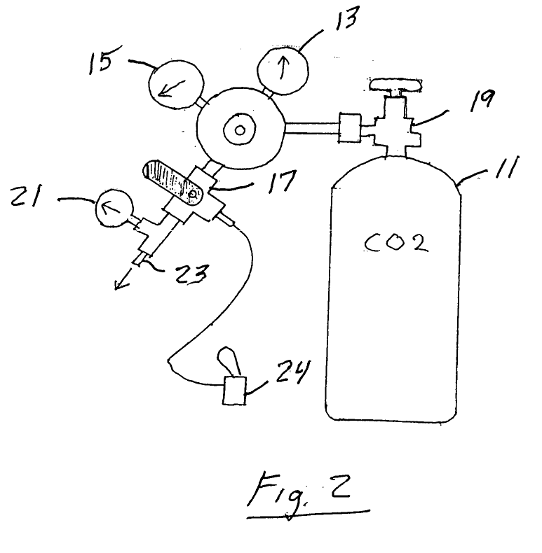

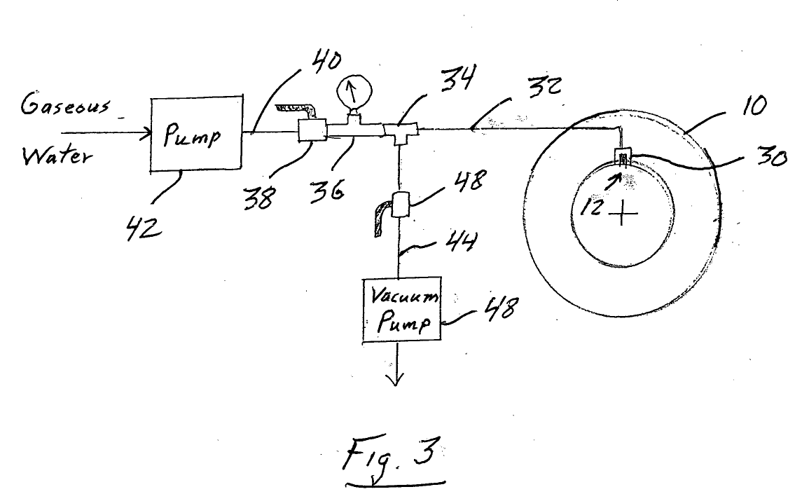

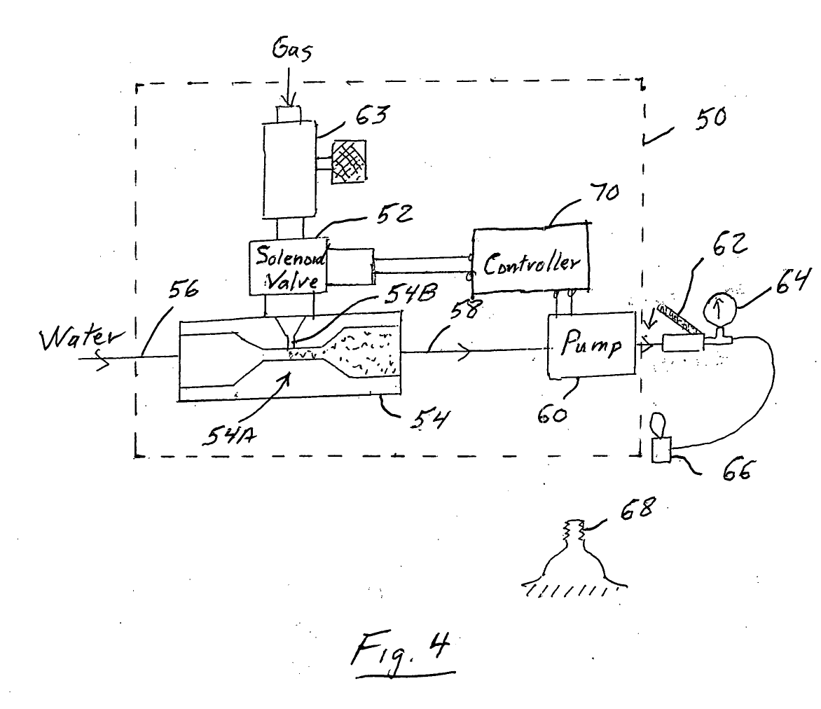

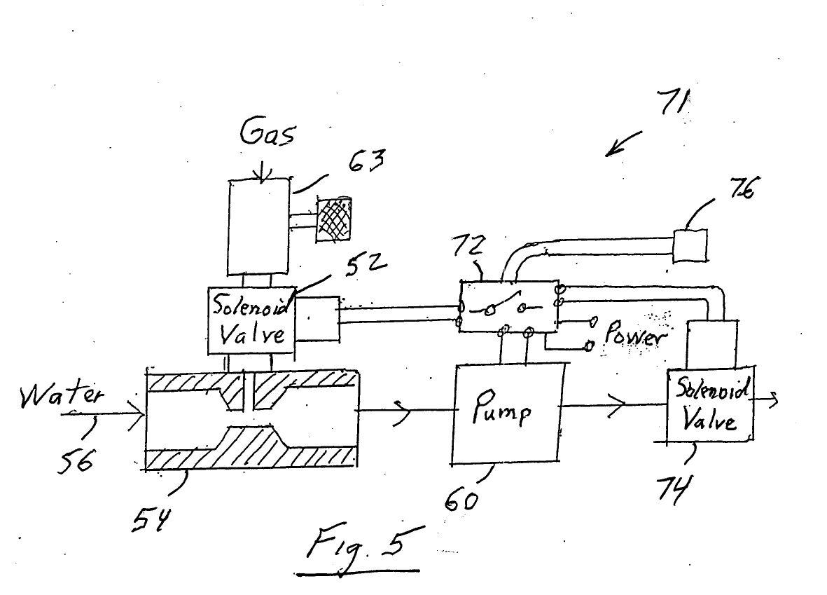

FIGS. 1A-1G illustrate the steps of a process of filling a tire with water in accordance with the invention, in which a water-soluble gas is repeatedly introduced into the tire to dilute the amount of air in the tire to a desired level.

FIG. 1A shows a tire 10 having a nozzle 12. Tire 10 is oriented such that nozzle 12 is at the top of the inner circumference of tire 10.

In FIG. 1B water is introduced into tire 10 through an input line 14 and a pressure gauge 16 until the surface of the water is at the level of nozzle 12. A water connector 18 connects input line 14 to nozzle 12. The water may be pure water or another aqueous liquid such as water in which a highly water-soluble gas such as CO₂ has been dissolved. Examples of other highly water-soluble gases that could be used instead of CO₂ are chlorine, fluorine, nitrogen dioxide, sulfur dioxide, acetylene, methyl acetylene, methyl ether, ammonia, aminines, ethylene, ethylene chloride, ethane, calorene, ethylene, chlorinated hydrocarbon, fluorinated hydrocarbon, Freon and bromotrifluoro methane. In general, the solubility of the water-soluble gas should exceed 100 ppm at 30 psi and a temperature of 90 degrees F.

The water may be injected into tire 10 with a piston pump, which can be a small as a home-use high pressure washer. The piston pump can provide a very homogeneous gaseous water solution with no separated gas bubbles in the water. Alternatively, a “Procon” rotary vane pump can be employed.

The water may initially be filled to a level above nozzle 12. When connector 18 is removed from nozzle 12, the water will drain out until its surface is level with nozzle 12. The trapped air above the water will be at a pressure of one atmosphere.

Next, as shown in FIG. 1C, while the tire 10 is sealed, a highly-water soluble gas is introduced into tire 10 to a predetermined pressure. This is done through a gas line 20 and a three-way valve 22. A gas connector 24 connects gas line 20 to nozzle 12. Normally, the gas that is used will be the same gas that is in the gaseous water that was previously injected into tire 10. When this step of the process is completed, the space above the water in tire 10 will be occupied by a diluted mixture of air and the water-soluble gas. For example, if CO₂ is introduced to tire 10 at a pressure of 6 atmospheres, the air and CO₂ will be mixed in a volumetric ratio of 1:6.

After the pressure in tire 10 has reached the desired level, three-way valve 22 is switched to allow the gas mixture within tire 10 to vent to the atmosphere, as shown in FIG. 1D. As a result, the space above the level of the water is filled with the diluted 1:6 mixture of air and the water-soluble gas at one atmosphere.

The steps shown in FIGS. 1C and 1D may be repeated at least one additional time. Following each repetition, the proportion of air remaining in tire 10 is reduced. In the example given above, if the steps shown in FIGS. 1C and 1D are repeated one more time, the ratio of air to CO₂ will be 1:36; if they are repeated two more times, the ratio of air to CO₂ will be 1:216. In general, the fractional amount of air remaining in the tire is expressed by the formula (1/X)^{Y}, where X is the pressure in the tire (in atmospheres) following the injection of the water-soluble gas into the tire (FIG. 1C) and Y is the total number of times that the steps shown in FIGS. 1C and 1D are performed. Thus, the fractional amount of air remaining in the tire can be reduced to any desired level by repeating the steps shown in FIGS. 1C and 1D a sufficient number of times.

When the desired fraction of air in tire 10 has been reached, gas connector 24 is disconnected from nozzle 12 and water connector 18 is reconnected to nozzle 12. Pure water or gaseous water is injected into tire 10 until a desired pressure is reached. This step of the process is illustrated in FIG. 1E. As shown, the mixture of the remaining air and the water-soluble gas is compressed into a relatively small volume within tire 10.

Next, as shown in FIG. 1F, water connector 18 is disconnected, and tire 10 is agitated by spinning for a predetermined period of time to dissolve the gas mixture into the water. The time required is typically about one to five minutes.

As shown in FIG. 1G, water connector 18 is reconnected to nozzle 12, and water is injected into tire 10 up to the desired standing pressure, which is indicated by pressure gauge 16.

The standing pressure should be at least high enough to prevent the dissolved gas from coming out of solution as tire 10 heats up during use. The required standing pressure depends on the solubility of CO₂ in water and the temperature to which the tire will be heated in operation. For example, if CO₂ is dissolved in water to 0.5 volume solubility, the nature's pressure of the CO₂ at 160° F. is 30 psig. Therefore, if water is injected into tire 10 to a pressure of 30 psig, the CO₂ will remain in solution when the tire is heated to 160° F. Normally, the temperature of water filled tires does not exceed about 160° F. in ambient temperatures up to 90° F.

To generalize this discussion, the amount of the water-soluble gas dissolved in the water will be (a) substantially greater (e.g., at least three (3) times greater) than the amount of the gas that occurs naturally in water that is exposed to the atmosphere and (b) less than the amount of the gas which would cause the nature's pressure of the gas at the maximum temperature to which the tire is expected to be heated to exceed the standing pressure of the water in the tire. Otherwise, if the amount of the water-soluble gas in the water is greater than the amount set forth in condition (b) above, the gas will separate from the water when the tire reaches the maximum temperature. As used herein the “nature's pressure” means the pressure that is required to suppress the gaseous water or the pressure that the gaseous water will show at a predetermined temperature and at a level of gas solubility in the water (or a level of “fizziness” of gaseous water).

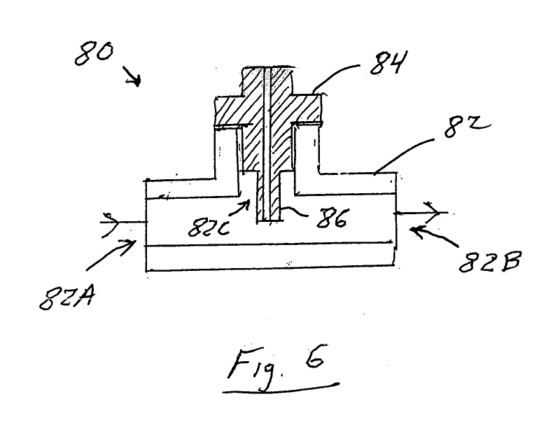

The anparatus shown in FIG. 2 can be used to inject the water-soluble gas into tire 10. A cylinder 11 containing CO₂ is connected through a primary pressure gauge 13 and a secondary pressure gauge 15 to a three-way valve 17. A cylinder valve 19 controls the flow out of cylinder 11. Three-way valve 17 can be set one of two ways, either to connect cylinder 11 to gas connector 24 or to connect gas connector 24 to an atmospheric vent port 23. To inject CO₂ into the tire, three-way valve 17 is set to connect cylinder 11 to gas connector 24 and valve 19 is opened. To vent the mixture of water-soluble gas and air, three-way valve 17 is set to connect gas connector 24 to atmospheric vent port 23. To measure the pressure in the tire, the operator can put a finger over vent port 23 and read the pressure in a tire gauge 21.

FIG. 3 illustrates apparatus that can be used to fill tire 10 with gaseous water in an alternative method according to the invention.

Initially, tire 10 is oriented such that nozzle 12 is at the top of the inner circumference of tire 10, and the air in tire 10 is released to a pressure of one atmosphere. A connector 30 is attached to nozzle 12. Connector 30 is connected via a line 32 to a three-way junction block 34. One inlet ofjunction block 34 is connected to a pressure gauge 36 and a valve 38 and via a line 40 to a pump 42. The inlet of pump 42 is connected to a source of gaseous water, for example, water containing dissolved CO₂.

The other inlet of junction block 34 is connected via a line 44 to a vacuum pump 46. Line 44 contains a valve 48.

The method will now be described.

Valve 38 is opened and valve 48 is closed. Gaseous water having dissolved CO₂ at, for example, 1.0 volume or less is injected into tire 10 until the surface of the gaseous water reaches the level of nozzle 12.

Valve 38 is closed, and connector 30 is removed and a tire valve (not shown) is screwed into nozzle 12. Connector 30 is then connected to the tire valve. Valve 48 is opened, and vacuum pump 46 is used to remove practically all of the air remaining in tire 10.

Connector 30 and the tire valve are removed and connector 30 is reconnected to nozzle 12. Valve 38 is opened, and an additional amount of the gaseous water is injected into tire 10 to a predetermined pressure of 3 atmospheres, for example, using pressure gauge 36. Connector 30 is removed and tire 10 is agitated, for example by spinning, for one minute or longer to dissolve any remaining gas inside tire 10 into the gaseous water.

Connector 30 is connected again to nozzle 12, and the gaseous water is injected into tire 10 to the desired standing pressure. This pressure is read with pressure gauge 36. As described above, the standing pressure is set to ensure that the dissolved gas (in this case CO₂) remains in solution while tire 10 is in operation.

As described above, tire 10 is advantageously filled with gaseous water. FIG. 4 shows a block diagram of an apparatus 50 for generating gaseous water.

Apparatus 50 includes a gas solenoid valve 52, which feeds a water-soluble gas such as CO₂ into a mixing block 54. The source of water-soluble gas, typically a tank, can be at a pressure in the range of 0-100 psi, for example. Mixing block 54 has a water inlet that is connected to a water line 56. Water line 56 is connected to a source of water which can be at a pressure in the range of 0-100 psi, for example. Mixing block 54 has a water outlet that is connected via a water line 58 to a pump 60. Gas solenoid valve 52 is supplied with the water-soluble gas through a gas flow regulator 63, which is optional.

Mixing block 54 can be made of plastic or stainless steel, for example. The water path through mixing block 54 contains a constricted zone 54A. A gas conduit 54B from gas solenoid valve 52 intersects constricted zone 54A. In one embodiment, the cross-sectional area of the water flow path in constricted zone 54A is 75 mm², or 15% of the cross-sectional area of the water flow path in other parts of mixing block 54. The cross-sectional area of gas conduit 54B can be 3 mm², for example.

As the water flows through mixing block 54, tiny bubbles of the water-soluble gas are injected into the water stream. Pump 60 can be a centrifugal pump, a piston pump, a rotary vane pump, or any other type of pump that will agitate the water sufficiently to dissolve the bubbles of water-soluble gas.

After the gaseous water leaves apparatus 50, it flows through a valve 62 and a pressure gauge 64 to a connector 66. Connector 66 can be connected to a tire valve 68.

When valve 62 is closed, pressure gauge 64 indicates the pressure in the tire. At the same time, a controller 70 detects an increase in the pressure in pump 60 and turns off the power to pump 60 and closes gas solenoid valve 52. If the operator wishes to add more gaseous water to the tire, he opens valve 62, reducing the pressure in pump 60. In response to this reduction in pressure, controller 70 turns pump 60 on and opens gas solenoid valve 52.

An alternative embodiment of an apparatus for generating gaseous water is shown in FIG. 5, wherein similar components are similarly numbered. In apparatus 71, a magnetic contactor 72 is connected to gas solenoid valve 52, pump 60 and a gaseous water solenoid valve 74. Magnetic contactor 72 is also connected to the power lines and is controlled by a switch 76. Again, gas flow regulator 63 is optional.

When switch 76 is turned to the on position, magnetic contactor connects the power lines to gas solenoid valve 52, pump 60 and gaseous water solenoid valve 74. As described above, bubbles of the water-soluble gas are injected into the water in mixing block 54, and these bubbles are dissolved in the water in pump 60 to form gaseous water. When switch 76 is turned to the off position, pump 60 is turned off and solenoid valves 52 and 74 are turned off.

FIG. 6 shows an alternative form of mixing block that can be used in the embodiments shown in FIGS. 4 and 5. Mixing block 80 comprises a T-block 82 having a water inlet 82A, a water outlet 82B and a gas inlet 82C. A gas fitting 84 is inserted into gas inlet 82C. Gas fitting 84 includes a tube 86 that extends into a central region of the water flow path between water inlet 82A and water outlet 82B. Preferably, the inside diameter of tube 86 should be 3 mm or smaller. As in the embodiments described above, a water-soluble gas is injected into the water flow path through tube 86, creating small bubbles of the water-soluble gas that are dissolved in the water in pump 60 to create gaseous water.

The apparatus shown in FIGS. 4, 5 and 6 is not limited to supplying gaseous water for tires but can be used in any situation where it is desired to dissolve a gas into a liquid. For example, in agricultural industries such as shrimp- and fish-farming, a source of aerated/ozonated water is required. By using air and ozone gas as the water-soluble gas, the apparatus shown in FIGS. 4, 5 and 6 can be used to provide a supply of aerated water for such operations. As another example, in hair, food and vegetable cleansing a source of carbonated/ozonated water is required. Application Ser. No. 11/046,588, filed Jan. 28, 2005, which is incorporated herein by reference in its entirety, describes a method of cleaning one's hair or body parts or foodstuffs by using carbonated water (H₂CO₃) which is carbon dioxide dissolved in water. Carbonated water is also referred to as carbonic acid or soda water. The cleansing solution can also be prepared by dissolving carbon dioxide gas and/or ozone gas in water. Ozonated water has been shown to be an excellent cleanser and germicidal agent.

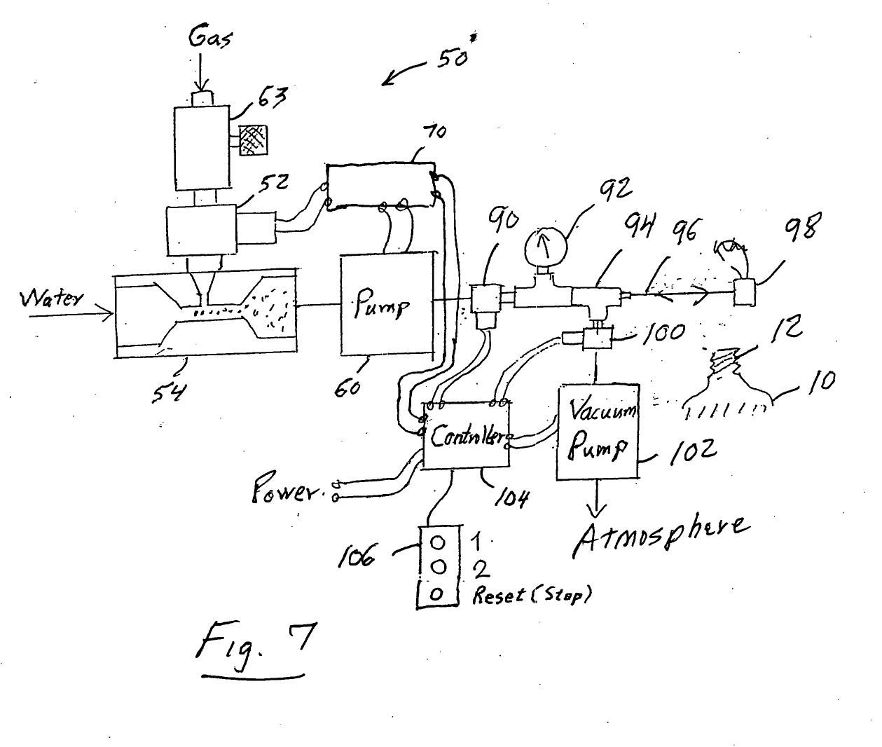

FIG. 7 illustrates a more advanced arrangement that may be used to carry out the process described above in connection with FIG. 3. The arrangement includes the apparatus 50 for providing a supply of gaseous water. The outlet of apparatus 50 is connected to a first solenoid valve 90, and gaseous water then passes through a pressure gauge 92 and a T-block 94. T-block 94 is connected via a gaseous water/air line 96 to a connector 98. Connector 98 attaches to nozzle 12. A third port of T-block 94 is connected via a second solenoid valve 100 to a vacuum pump 102 and to the atmosphere. Solenoid valves 90 and 100 and vacuum pumps 52, 60 and 102 are controlled by a controller 104, which is also connected to controller 70. Controller 104 receives power from the power lines and is regulated by a manual switch 106, which has three positions controlled by respective buttons—“1”, “2” and “reset (stop)”.

Initially, connector 98 is connected to nozzle 12, and manual switch 106 is set in the “1” position. In this position controller 104 closes solenoid valve 90, opens solenoid valve 100 and turns vacuum pump 102 on, opening a pathway to draw the gas out of tire 10. Acting via controller 70, controller 104 also closes solenoid valve 52 and turns off vacuum pump 60. After the gas has been evacuated from tire 10, the operator sets manual switch 106 to the “2” position. In this position, controller 104 opens solenoid valve 90, closes solenoid valve 100, and turns vacuum pump 102 off. Controller 104 also sends a signal to controller 70. Controller 70 thereupon turns pump 60 on and opens gas solenoid valve 52, causing apparatus 50 to generate gaseous water as described above. The gaseous water can have a solubility of 1.0 volume, for example. The operator can monitor the pressure in tire 10 by observing pressure gauge 92. When the desired standing pressure in tire 10 is reached, the operator pushes the “reset (stop)” button on manual switch 106, closes connector 98 and disconnects it from nozzle 12. With manual switch 106 in the “reset (stop)” position, controller 104 closes solenoid valves 90 and 100 and turns off vacuum pump 102. Controller 104 also sends out a signal which causes controller 70 to turn off pump 60 and close solenoid valve 52.

According to another aspect of this invention, a gaseous liquid generator uses a centrifugal pump to agitate a “rough” mixture of liquid and gas (in the form of small bubbles). Known gaseous liquid generators fall into several categories. In the first category, represented by U.S. Pat. Nos. 5,842,600 and 5,510,060, a gas and a liquid are injected into a block that contains a spiral or curved passageway. The gas and liquid are blended as they pass through the passageway. In the second category, represented by U.S. Pat. Nos. 5,417,146 and 5,743,433, a liquid is forcibly sprayed into a chamber that contains an atmosphere of the gas, causing the liquid to absorb the gas and fall to the bottom of the chamber as a gaseous liquid. In the third category, represented by U.S. Pat. No. 5,443,763, a gas and a liquid are injected into a cold chamber that is filled with a slush of the gaseous liquid. A rotating blade slowly agitates the mixture, naturally blending the gas and the liquid. The amount of gas into the gaseous liquid is controlled by the period of agitation. The rotation of the blade does not build up a high pressure. In the fourth category, represented by U.S. Pat. Nos. 4,643,857, 6,736,377 and 5,275,762, a liquid is discharged through an opening into a gaseous atmosphere, creating a suction head at the opening in a direction perpendicular to the flow of liquid and causing the gas to be absorbed into the liquid (a phenomenon frequently referred to as Venturi action). The velocity of the flow and the length of the discharge from the outlet determines the size of the head and the amount of gas that is absorbed into the liquid.

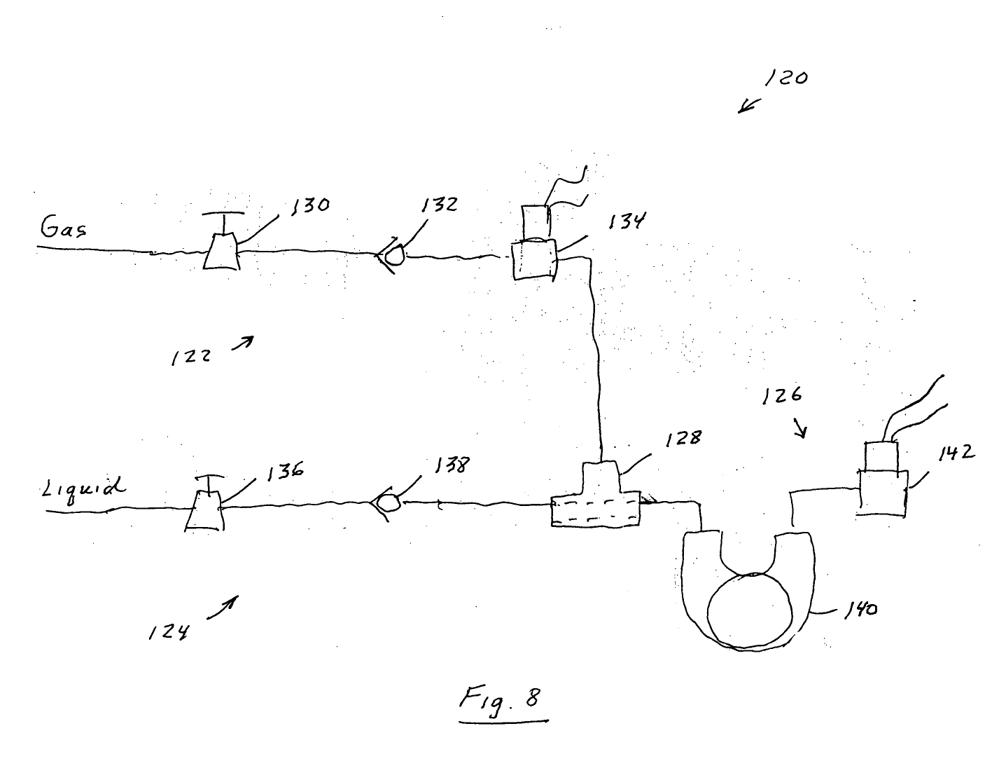

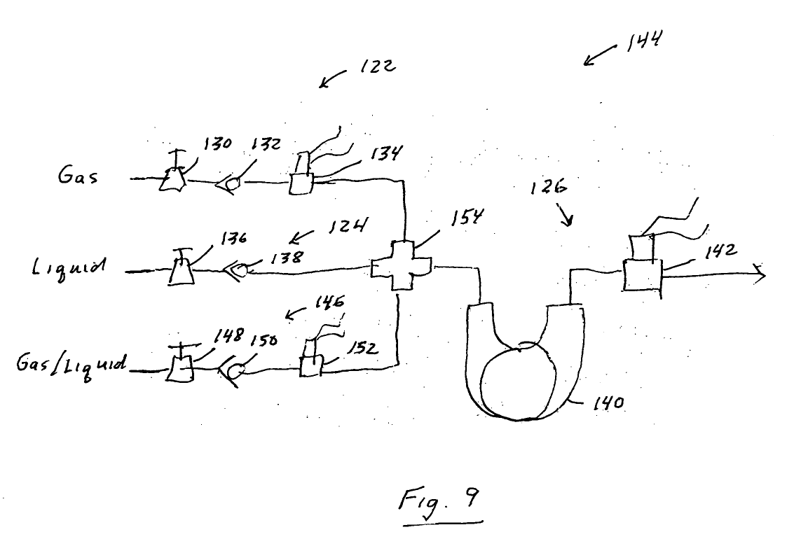

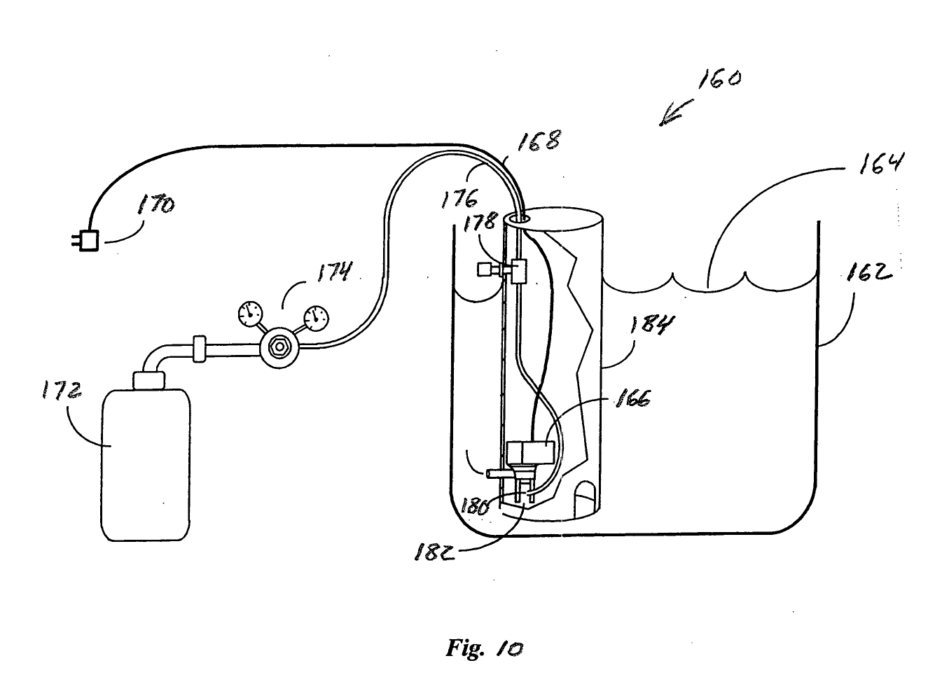

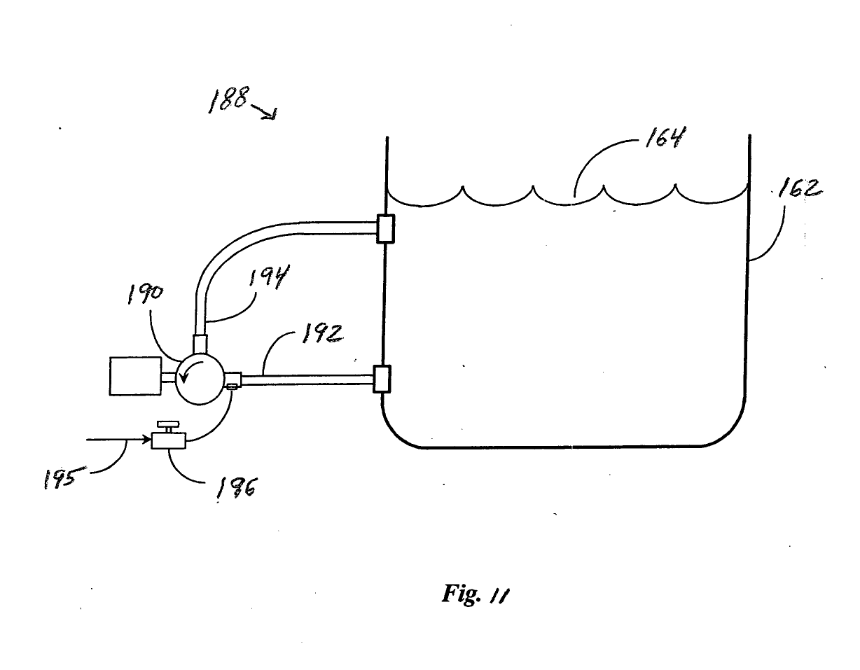

In contrast a gaseous liquid generator 120 in accordance with the invention is shown in the schematic diagram of FIG. 8. Gaseous liquid generator 120 includes a gas flow line 122, a liquid flow line 124 and a gaseous liquid flow line 126. Gas flow line 122 is connected to a first inlet port of a “T” mixing block 128; liquid flow line 124 is connected to a second inlet port of mixing block 128; gaseous liquid flow line is connected to the outlet port of mixing block 128.

Gas flow line 122 is connected to source of gas at constant pressure, which could be a gas tank or a gas pump operating through a pressure regulator. Connected in gas flow line 122 are a gas flow regulator 130, a back-flow valve 132, and a gas solenoid valve 134. Gas flow regulator 130 may be a needle valve.

Liquid flow line 124 is connected to a source of liquid at a constant pressure, which can be an elevated reservoir or the discharge of a liquid delivery pump. Connected in liquid flow line 124 are a liquid flow regulator 136 and a back-flow valve 138. Liquid flow regulator may be a gate valve.

The pressure of the gas in gas flow line 122 is normally set at a higher level than the pressure of the liquid in liquid flow line 124. If this is the case, no Venturi action is required in mixing block 128, and the liquid flow channel in mixing block 128 may have a uniform cross-sectional area. In other embodiments, the liquid flow channel in mixing block 128 may include a constricted “bottleneck” region where the gas flow channel intersects the liquid flow channel.

Connected in gaseous liquid line 126 are a centrifugal pump 140 and a gaseous liquid solenoid valve 142. Centrifugal pump 140 is preferably a high-pressure, closed-impeller type, and it has a housing that is made of stainless steel, plastic or some other non-corrodible material. Pumps that can be used include the LGB plastic open impeller centrifugal pump (Model CF 1493), the PEDROLLO stainless steel closed impeller centrifugal pump (Model JCRM1B), and the RESUN plastic magnet centrifugal pump (Model MD-40). Solenoid valve 142 may be omitted in some embodiments.

The gas in gas flow line 120 and the liquid in liquid flow line 124 are pre-mixed roughly in the “T” mixing block 128 such that small bubbles of the gas are entrapped in the gas/liquid mixture as it leaves mixing block 128. The impeller vanes of centrifugal pump 140 agitate this gas/liquid mixture, and the high-pressure inside centrifugal pump 140 forcibly dissolves the small gas bubbles to produce a homogeneous gaseous liquid at the outlet of centrifugal pump 140.

The mixing action inside the housing of centrifugal pump 140 agitates and thoroughly blends the rough mixture of gas and liquid that leaves mixing block 128. The rotating impellers inside centrifugal pump 140 provide a pumping action and a high pressure which produce a homogeneous blend of gas and liquid. The amount of gas in the gaseous liquid produced by centrifugal pump 140 is controlled by adjusting gas flow regulator 130 and liquid flow regulator 136. In some embodiments, liquid flow regulator 136 is maintained at a constant setting and the proportion of gas in the gaseous liquid is controlled by adjusting gas flow regulator 130.

Gas solenoid valve 134 is closed whenever the inlet or outlet to centrifugal pump 140 is turned off. This prevents the gas from flooding centrifugal pump 140, which can cause centrifugal pump 140 to surge.

Back-flow valve 132 prevents the liquid in liquid flow line 124 from flowing back into gas flow line 120 when centrifugal pump 140 is turned off. Back-flow valve 136 prevents the gaseous liquid from flowing back into liquid flow line 124.

The method and apparatus of this invention can be used to produce gaseous liquids containing more than one gas and/or more than one liquid. For example, FIG. 9 shows a gaseous liquid generator 144 that is capable of producing a gaseous liquid containing two liquids or gases. Components that are the same as those shown in FIG. 8 are numbered identically. Gaseous liquid generator 144 comprises a third gas or liquid flow line 146. Connected in gas/liquid flow line 146 are a flow regulator 148, a back-flow valve 150 and a solenoid valve 152. If flow line 146 is a liquid flow line, flow regulator 148, back-flow valve 150 and solenoid valve 152 may be identical to the corresponding elements in liquid flow line 124. If flow line 146 is gas flow line, flow regulator 148, back-flow valve 150 and solenoid valve 152 may be identical to the corresponding elements in gas flow line 122.

Flow lines 122, 124 and 146 are connected to the inlet ports of an “X” mixing block 154. The outlet port of “X” mixing block 154 is connected to centrifugal pump 140.

In the same manner described above in connection with gaseous liquid generator 120, the gas in gas flow line 120, the liquid in liquid flow line 124, and the gas or liquid in gas/liquid flow line 146 are pre-mixed roughly in the “X” mixing block 154 such that small bubbles of the gas are entrapped in the gas/liquid mixture as it leaves mixing block 154. The impeller vanes of centrifugal pump 140 agitate this gas/liquid mixture, and the high-pressure inside centrifugal pump 140 forcibly dissolves the small gas bubbles to produce a homogeneous gaseous liquid at the outlet of centrifugal pump 140.

For example, gaseous liquid generator 144 may be used to produce a carbonated beverage, where gas flow line 122 would supply carbon dioxide gas, liquid flow line 124 would supply water, and gas/liquid flow line 146 would supply a liquid syrup.

There are numerous other uses of the gaseous liquid generator of this invention. For example, a gaseous liquid generator can be used to provide aerated/ozonated water for agricultural uses such as fish and shrimp farming and in sewerage plants. Or ozone and/or carbon dioxide can be dissolved in water and used to wash or sterilize hair, feet, and other body parts.

FIG. 10 shows an arrangement 160 for generating carbonated or ozonated water for these purposes. Arrangement 160 includes a tub 162 filled with water 164. A submersible pump 166 is immersed in water 164. Submersible pump 166 is powered through an electrical connection 168 from a plug 170 having an earth-ground connection. Carbon dioxide gas and/or ozone gas from a pressurized supply 172 flows through a pressure regulator 174 and tubing 176, and through a flow regulator 178 and out of a nozzle 180 at the suction inlet 182 of pump 166. If ozone gas is to be injected into water 164, supply 172 may include an air pump and an ozone generator, which converts air into ozone gas. Pump 166 and other apparatus may be enclosed in a structure 184 in tub 162, Water 164 is drawn into pump 166 through inlet 182. Carbon dioxide and/or ozone gas is ejected through nozzle 180 and dissolved in water 164 in pump 166 as described above. The carbonated/ozonated water is discharged through a nozzle 186 back into tub 162.

The gas dissolved in water 164 will escape into the atmosphere, but over time the injection of gas into water 164 by pump 166 will keep the gas content of water 164 stable. The injection rate of the gas is controlled by adjusting either the pressure regulator 174 or the flow regulator 178. Pump 166 is preferably made of stainless steel or plastic or some other non-corrodible material, because carbonated/ozonated water can be somewhat corrosive.

FIG. 11 shows an alternative arrangement 188 for generating carbonated/ozonated water by a pump external to tub 162. A centrifugal pump 190 is mounted outside tub 162 and draws water 164 from tub 162 via a suction inlet line 192 and discharges it back into tub 162 via a discharge line 194. The connection between suction inlet line 192 and tub 162 is located below the connection between discharge line 194 and tub 162. Carbon dioxide and/or ozone gas is fed into suction inlet line 192 through a flow regulator 196. The level of carbonation/ozonation in water 164 is regulated a manner similar to that described above in connection with FIG. 10.

Thus the tub 162 shown in FIGS. 10 and 11 can be used as a source of ozonated water for foot soaking, hair and skin cleansing and sterilizing.

Moreover, the arrangements shown in FIGS. 10 and 11 have many uses. For example, ozone gas can be used to kill algae and plankton in ornamental ponds. Ozone gas can also be used to kill bacteria in water in water recycling plants, sewerage plants and water bottling plants.

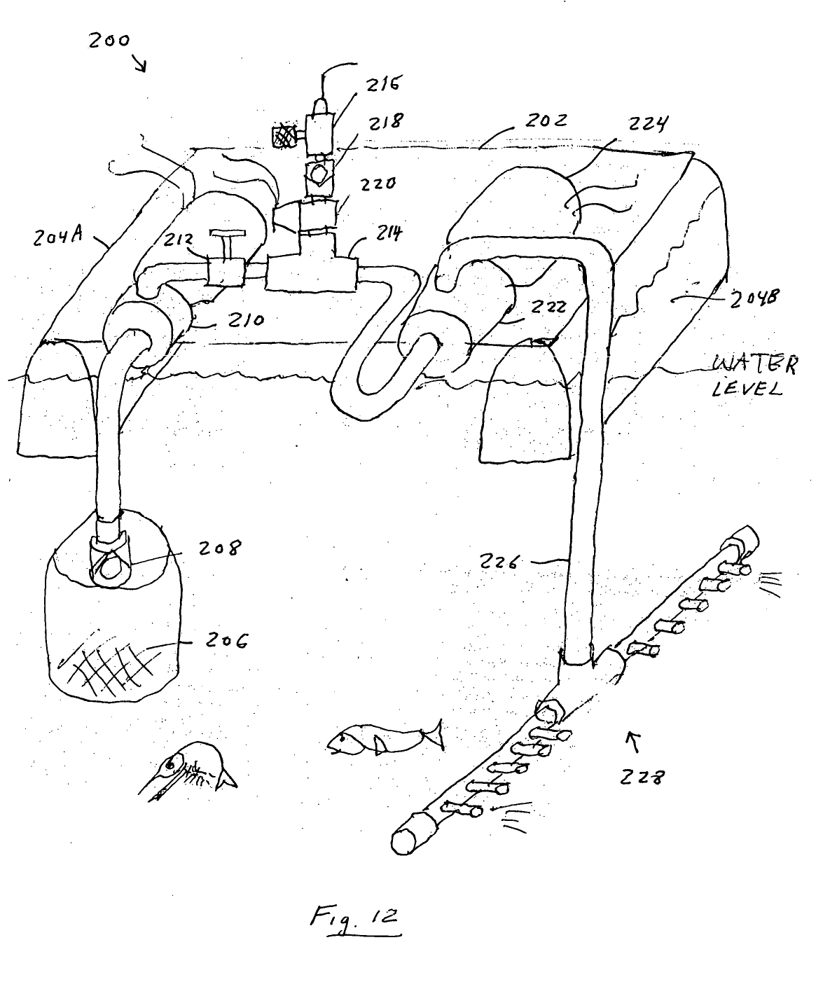

FIG. 12 shows an aerator/ozonator 200 for an open pond in accordance with the invention. Aerator 200/ozonator is mounted on a platform 202 that is supported by two floats 204A and 204B. Water is drawn from the pond through a strainer 206 and a foot valve 208 (which acts as a back-flow valve) by a water delivery pump 210. Pump 210 forces the water through a flow regulator 212 to an inlet port of a “T” mixing block 214. Pressurized air or ozone gas (from a tank or pump) flows through a flow regulator 216, a back-flow valve 218, and a solenoid valve 220 to another inlet port of mixing block 214. The air/ozone and water are roughly mixed in mixing block 214 and delivered to a centrifugal pump 222, where the air/ozone is dissolved in the water, as described above. Centrifugal pump 222 is driven be an electric motor 224. The aerated/ozonated water leaves pump 222 and flows through a downward extending output line 226 to a discharger 228, which discharges the aerated/ozonated water back into the pond.

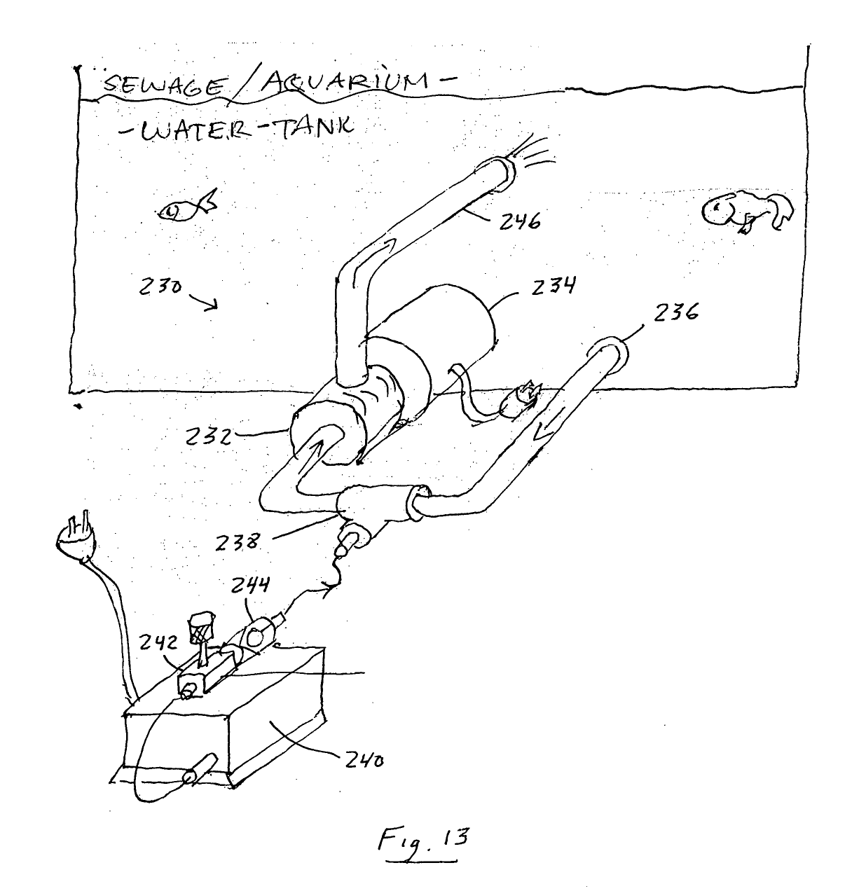

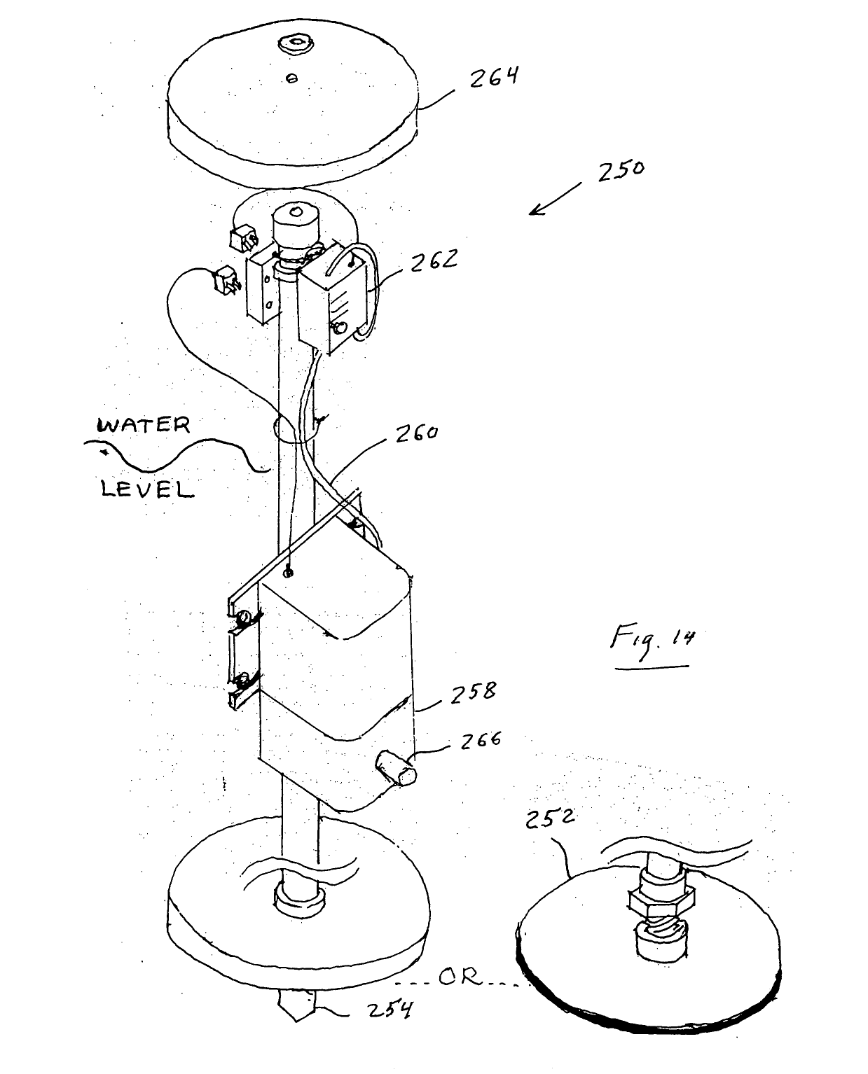

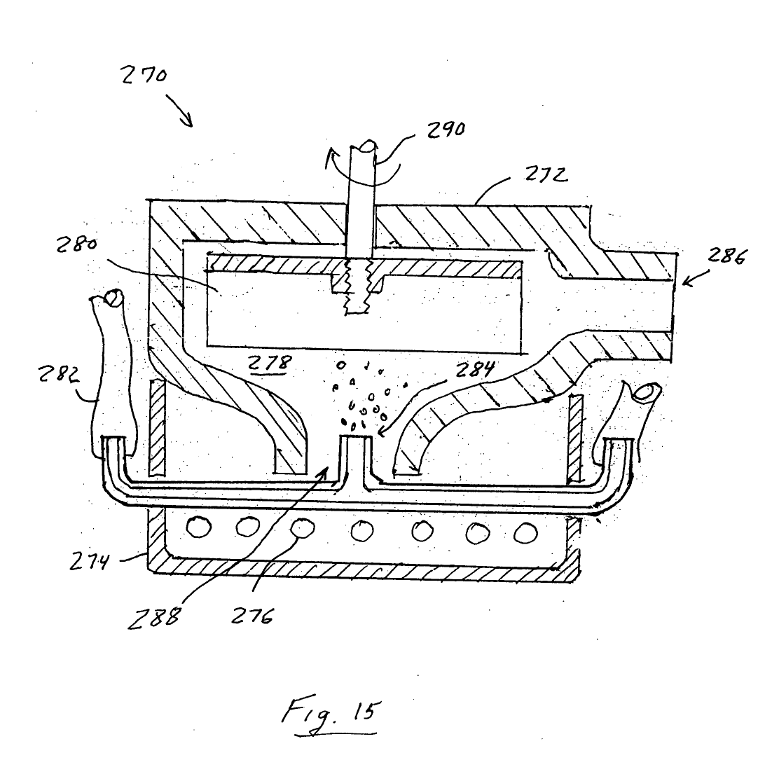

An aerator/ozonator 230, shown in FIG. 13, can be used to provide aerated/ozonated water for an aquarium or tank, for example, a tank in a sewerage plant. Aerator 230 uses a submersible centrifugal pump 232, driven by a motor 234, which draws the water through a suction inlet 236 and a mixing block 238. An air pump or ozone gas generator 240 provides pressurized air at an inlet of mixing block 238 through a flow regulator 242 and a back-flow valve 244. The air/ozone and water are roughly mixed in mixing block 238 and then pass through centrifugal pump 232, where the air/ozone is dissolved in the water and discharged back into the tank through aerated water discharge outlet 246.

FIG. 14 shows an “aerator/ozonator stick” 250 that could be used in a shrimp farm or waste water tank or pond, for example. Aerator stick 250 is supported on the bottom of the tank or pond by a flat base unit 252 that rests on the floor of the pond or tank or by a post 254 that is driven into the floor of the pond or tank. A vertical shaft 256 extends upward from base unit 252 or post 254 to the water surface. Mounted on shaft 256 below the water surface is a submersible centrifugal pump 258. Air/ozone is supplied to pump 258 through an air line 260 that extends from an air pump or ozone generator 262 that in this embodiment includes a check valve and a flow control. Optionally, a shield 264 can be mounted over air pump or ozone gas generator 262 to protect air pump or ozone gas generator 262 from sun and rain. The air/ozone is fed through line 260 into centrifugal pump 258, where it is dissolved in the water, and the aerated/ozonated water is discharged into the tank or pond through a discharge outlet 266. Centrifugal pump 258 has a water inlet similar to that of submersible centrifugal pump 270, shown in FIG. 15 and described below, so that the water inlet of centrifugal pump 258 is used as a mixing block.

FIG. 15 shows an alternative type of submersible centrifugal pump in which the water inlet is used as a mixing block. In submersible centrifugal pump 270, the air or ozone is delivered directly into a centrifugal pump housing 272, which has a water inlet 288 and an aerated/ozonated water discharge outlet 286. Pump housing 272 rests on a strainer/stand 274. Holes 276 formed in strainer/stand 274 admit water into a pump chamber 278, which includes a pump vane 280 attached to a rotating drive shaft 290. Drive shaft 290 is driven by a pump motor (not shown). Air/ozone gas is forced into chamber 278 by an air pump or ozone gas generator (not shown) through an air/ozone line 282 and an air/ozone inlet nozzle 284, which preferably is centrally located in water inlet 288 and which produces small bubbles of air/ozone directly below the pump vane 280. The area of nozzle 284 is typically about 5% of the area of water inlet 288. The water and air/ozone are roughly mixed at the center of water inlet 288. As the pump vane 280 rotates, water is drawn from strainer/stand 274 into chamber 278, and the small air/ozone bubbles produced by nozzle 284 are dissolved in the water by the high pressure created by pump vane 280, producing homogeneous aerated/ozonated water. The homogeneous aerated/ozonated water is discharged from pump 270 through a discharge outlet 286.

In one embodiment, the action of pump 270 produces a vacuum pressure (suction head) of 1 to 20 feet of water at air inlet nozzle 284, thus reducing the power demands on the air/ozone pump that feeds air line 282. In cases where pump 270 is placed at sufficiently shallow depth in the water such that the water pressure surrounding pump 270 is less than the suction head created by pump 270, no air/ozone pump would be required.

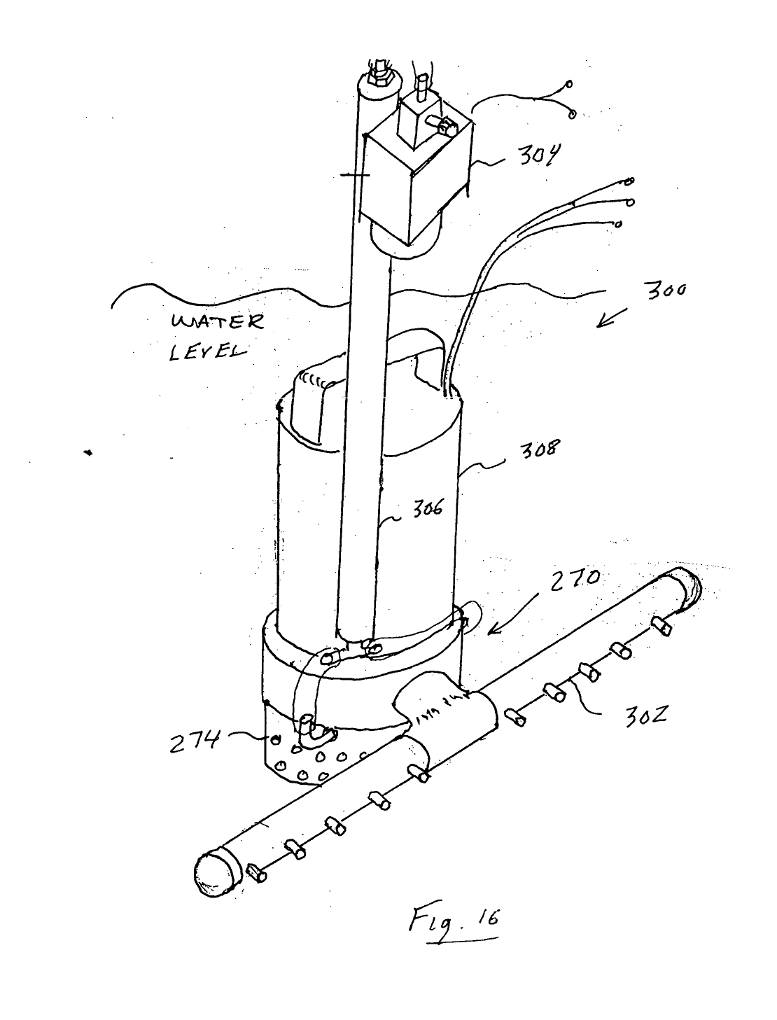

FIGS. 16-20 illustrate several types of aerators that can use centrifugal pump 270.

In aerator/ozonator 300, shown in FIG. 16, the strainer/stand 274 of pump 270 is placed on the bottom of a pond or tank. Centrifugal pump 270 delivers aerated/ozonated water to a jet discharge outlet 302. Air is supplied to pump 270 by an electromagnetic piston air pump 304, which includes an air flow controller. Air pump 304 or an ozone gas generator is mounted above the surface of the water on a pole 306 which serves as a conduit for the air/ozone to pump 270. The motor that drives pump 270 is housed in a water-tight container 308.

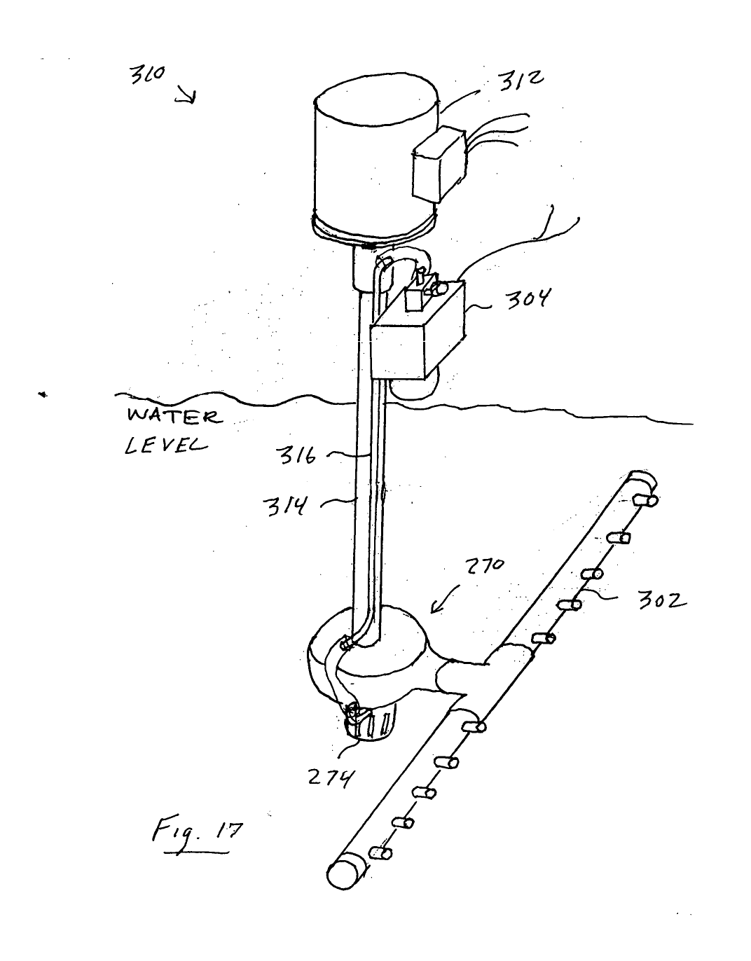

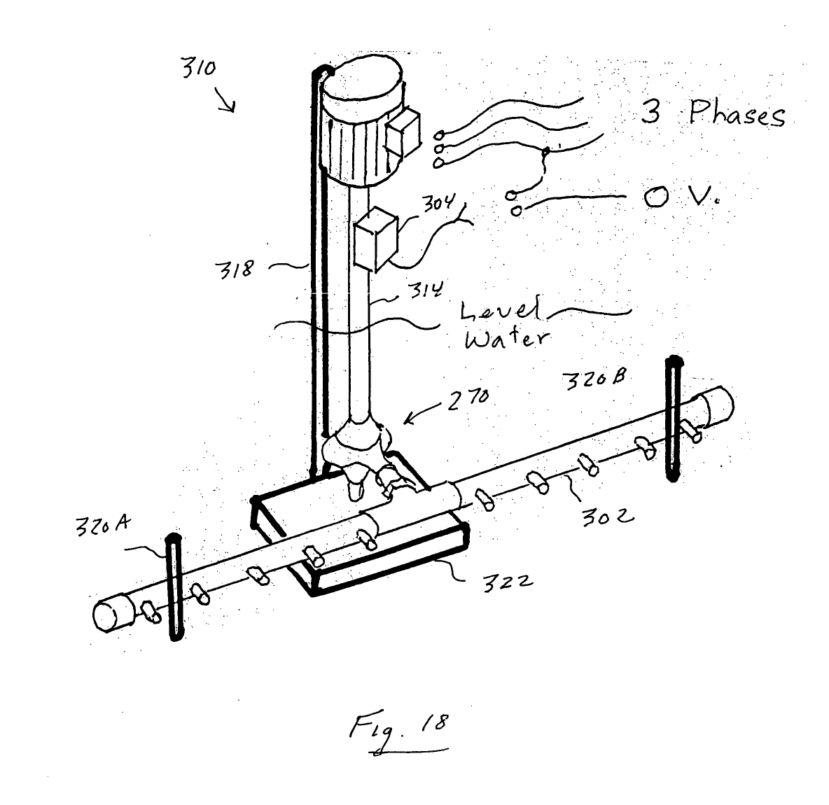

Aerator/ozonator 310, shown in FIG. 17, is similar to aerator/ozonator 300 but the centrifugal pump motor is contained in a housing 312 that is mounted on a drive shaft housing 314, which contains drive shaft 290. Air/ozone is supplied to pump 270 via a conduit 316, which may be attached to drive shaft housing 314.

FIG. 18 shows aerator/ozonator 310 mounted on the floor of a pond using a central pole 318 and two wing poles 320A and 320B, each of which is attached to or driven into the floor of the pond. Motor housing 312 is fastened to central pole 318 and the ends of jet discharge outlet 302 are fastened to wing poles 320A and 320B. Centrifugal pump 270 is mounted on a floor block 322 which rests on the bottom of the pond.

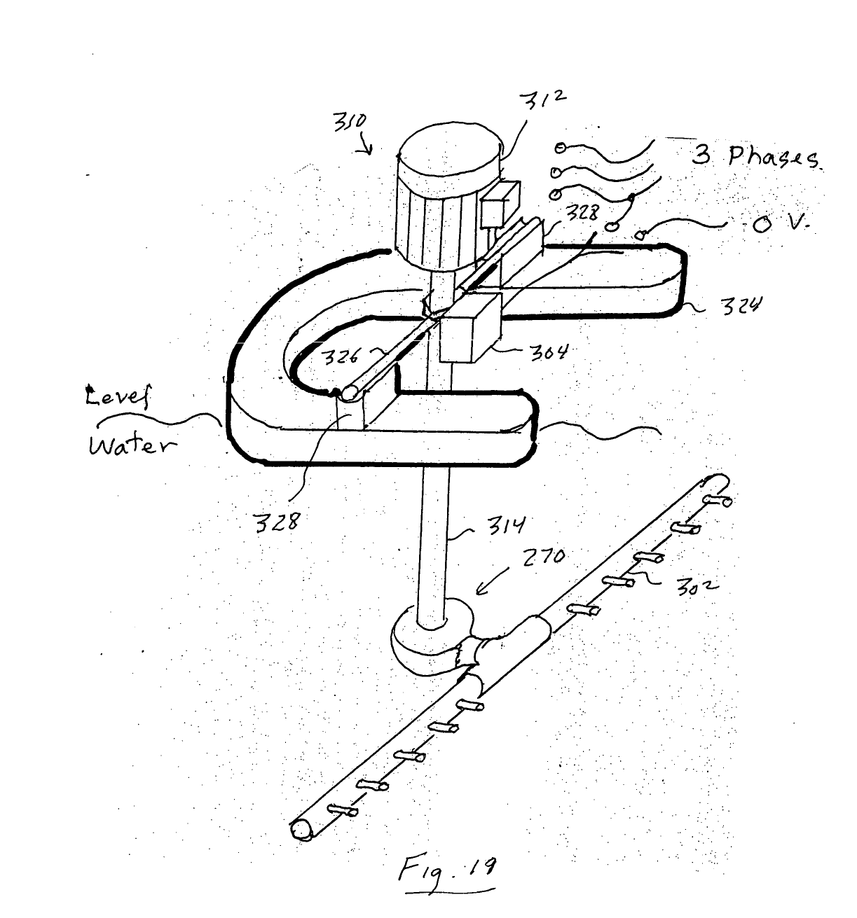

FIG. 19 shows aerator/ozonator 310 mounted to a U-shaped float 324 instead of on the pond floor. Aerator/ozonator 310 is suspended from a horizontal hanging rod 326, which is attached to float 324 by means of mounting blocks 328. Drive shaft housing 314 is attached to hanging rod 326.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A motor vehicle tire substantially filled with gaseous water, wherein the gaseous water contains in solution an amount of a gas that is equal to at least three times the amount of the gas that is found naturally in water that is exposed to the atmosphere.

2. The motor vehicle tire of claim 1 wherein the gas is carbon dioxide.

3. A motor vehicle tire substantially filled with gaseous water, wherein the water contains in solution a gas selected from the group consisting of chlorine, fluorine, nitrogen dioxide, sulfur dioxide, acetylene, methyl acetylene, methyl ether, ammonia, aminines, ethylene, ethylene chloride, ethane, calorene, ethylene, chlorinated hydrocarbon, fluorinated hydrocarbon, Freon and bromotrifluoro methane.

4. A method of filling a tire with gaseous water comprising:
(a) partially filling the tire with an aqueous liquid, leaving a remaining space in the tire filled with gas;
(b) injecting a water-soluble gas into the remaining space to produce a gaseous mixture;
(c) venting the gaseous mixture to the atmosphere;
(d) repeating (b) and (c) a number of times to produce a diluted gaseous mixture; and
(e) agitating the tire to dissolve the diluted gaseous mixture in the aqueous liquid.

5. The method of claim 4 comprising adding an additional volume of the aqueous liquid into the tire between (d) and (e).

6. The method of claim 4 wherein the aqueous liquid is water.

7. The method of claim 4 wherein the aqueous liquid comprises CO₂ dissolved in water.

8. The method of claim 4 wherein the water-soluble gas comprises CO₂.

9. The method of claim 4 comprising, after (e), injecting additional aqueous liquid into the tire until a desired standing pressure is reached.

10. A method of filling a tire with gaseous water comprising:
(a) partially filling the tire with a solution of CO₂ in water, leaving a remaining space in the tire filled with air;
(b) injecting CO₂ gas into the remaining space to produce an air/CO₂ mixture;
(c) venting the air/CO₂ mixture to the atmosphere;
(d) repeating (b) and (c) a number of times to produce a diluted air/CO₂ mixture;
(e) injecting an additional volume of the solution of CO₂ in water into the tire;
(f) agitating the tire to dissolve the diluted air/CO₂ mixture in the solution of water and CO₂; and
(g) injecting additional solution of CO₂ in water into the tire until a desired standing pressure is reached.

11. A method of filling a tire with gaseous water comprising:
(a) partially filling the tire with gaseous water, leaving a remaining space in the tire filled with gas;
(b) evacuating a portion of the gas from the remaining space;
(c) injecting more gaseous water into the tire; and
(d) agitating the tire.

12. The method of claim 11 comprising, after (d), injecting additional gaseous water into the tire until a desired standing pressure is reached.

13. The method of claim 11 wherein the gaseous water comprises a solution of CO₂ in water.

14. An apparatus for generating a gaseous liquid comprising:
a mixing block comprising
a first flow path extending between a first inlet and an outlet, said first flow path comprising a constricted region; and
a second flow path extending between a second inlet and said constricted region of said first flow path;
a source of liquid coupled to said first inlet;
a source of gas coupled to said second inlet; and
an inlet port of a pump coupled to said outlet.

15. The apparatus of claim 14 further comprising:
a first port of a T-block coupled to an outlet port of said pump;
a vacuum pump coupled to a second port of said T-block;
a first valve connected between said source of gas and said mixing block;
a second valve connected between said outlet port of said pump and said first port of said T-block; and
a third valve connected between said vacuum pump and a second port of said T-block.

16. A gaseous liquid generator comprising:
a mixing block having a first flow path extending between a first inlet and an outlet and a second flow path extending between a second inlet and an intersection point with said first flow path;
a source of liquid coupled via a liquid flow line to said first inlet of said mixing block;
a source of gas coupled via a gas flow line to said second inlet of said mixing block; and
a centrifugal pump coupled to said outlet of said mixing block.

17. The gaseous liquid generator of claim 16 wherein said mixing block comprises a third flow path extending between a third inlet and said first flow path, said gaseous liquid generator further comprising a source of a gas or liquid coupled via a gas/liquid flow line to said third inlet of said mixing block.

18. The gaseous liquid generator of claim 16 wherein said source of gas is an air pump and said source of liquid is the water in a fish or shrimp pond, said gaseous liquid generator functioning as an aerator.

19. The gaseous liquid generator of claim 18 wherein said centrifugal pump comprises:
a housing comprising a pump chamber and an inlet and an outlet, said inlet being located at a bottom of said chamber;
a pump vane within said chamber; and
an air line connected to a nozzle, said nozzle being positioned within said pump chamber.

20. The gaseous liquid generator of claim 19 wherein said nozzle is positioned near a center of said inlet.

21. The gaseous liquid generator of claim 20 wherein said centrifugal pump comprises a strainer/stand below said housing and in flow communication with said inlet, said strainer/stand positioned of a bottom of said pond.

22. The gaseous liquid generator of claim 21 further comprising a pump motor, said pump motor being mounted in a container above said pump and below the surface of said water.

23. The gaseous liquid generator of claim 21 further comprising a pump motor a pump drive shaft and drive shaft housing, said pump motor being mounted on said drive shaft housing above the surface of said water.

24. A method of cleansing hair or skin comprising:
providing a tub;
introducing water into the tub;
placing a submersible pump into the water;
turning the submersible pump on;
injecting a gas into a water inlet of the submersible pump, wherein the gas is selected from the group consisting of carbon dioxide and ozone and combinations thereof, the pump thereby generating carbonated and/or ozonated water; and
immersing the hair or skin in the carbonated or ozonated water.

25. A method of cleansing hair or skin comprising:
providing a tub;
introducing water into the tub;
connecting the tub to an inlet of centrifugal pump through an inlet line;
connecting an outlet of the centrifugal pump to the tub through an outlet line;
turning the centrifugal pump on thereby causing the water to flow in the tub to circulate through the centrifugal pump;
injecting a gas into the inlet of the submersible pump, wherein the gas is selected from the group consisting of carbon dioxide and ozone and combinations thereof, the pump thereby generating carbonated and/or ozonated water and pumping the carbonated and/or ozonated water into the tub; and
immersing the hair or skin in the carbonated or ozonated water.
